(19) United States
(12) Patent Application Publication
(10) Pub. No.: US 2005/0015866 A1
(43) Pub. Date: Jan. 27, 2005

(54) Ventilated, breathing-powered protection suit

(76) Inventor: Robert Bruce Steinert, North Branch, NJ (US)

Correspondence Address: ROBERT B. STEINERT, 32 VILLAGE WAY, NORTH BRANCH, NJ, 08876, US

(21) Appl. No.: 10/613,948

(22) Filed: Jul. 7, 2003

(51) Int. Cl. A62B 17/00; A41D 13/00

(52) U.S. Cl. 2/457

(57) ABSTRACT

Protective suits are used to protect the wearer against hazardous materials such as chemicals, pathogens, radioactive particles, electromagnetism, physical trauma and for rain protection. They are used to protect the wearer's surrounding in cleanrooms. Medical protective suits are used to prevent the spread of pathogens from the wearer. Unfortunately, they can cause heat stress by reducing air circulation. This invention discloses a protective suit with a breathing mask and dual one-way valves to draw air through the suit's interior using the forces generated by the wearer's breathing. Filters can be placed in the suit, or the suit can be made of a filter material to protect the wearer and the surroundings. The disclosed suit is lighter, less expensive to produce and more mobile than prior-art protective suit designs that use powered or externally supplied ventilation and cooling devices.

### BACKGROUND OF THE INVENTION

Protective suits are in wide use. They are designed to protect the wearer from Hazardous Materials (pathogens, chemicals, dust, and radioactive contaminates). They are used to protect clean environments from potentially harmful sources from the wearer, such as particular contaminations in cleanrooms. They are used to protect people and animals from pathogens spread by the wearer such as in the surgical operating rooms of medical facilities and for the protection of laboratory animals, which must be pathogen free. They are used to protect workers from electrical, electromagnetic and radioactive sources. They are used for rain protection. They are used for physical trauma protection in applications such as construction work, high-speed motor sports and skiing.

The impermeable or semi-permeable construction of these suits is known to limit or eliminate air circulation on the wearer's body reducing the required body heat loss and evaporation rates. Exhaustion, discomfort and heat stress can result from wearing such suits. To reduce the heat and moisture buildup, the wearer may open the suit's closures to increase ventilation, circumventing the suit's protection.

To reduce these adverse effects, ventilated protection suits of various designs have been disclosed. They use: an external source of supplied air such as compressed air or compressed bottled air, a powered blower carried by the wearer to supply cooling and/or breathing air, or they supply coolants, either gases or liquids, that are contained in circulation devices in the suit's interior. The previously disclosed suits are expensive to produce, add physical weight to the wearer or function for limited periods. Attached supply lines limit the wearer's movement.

Unlike previous designs, this patent discloses the use of a protective suit fitted with a breathing mask with dual one-way valves which draws the air, to be inhaled by the wearer, through a protective suit's interior. The air drawn through the suit replaces the cooling and evaporation lost when a non-ventilated protective suit is worn. The suit eliminates the need for the powered ventilation or external supplies of air or coolants required by the previously disclosed suits. It is less expensive to produce, lighter to wear, more comfortable and less restrictive of the wearer's movements than the previously disclosed ventilated or cooled suits. It eliminates the tendency to circumvent the protection of non-ventilated or non-cooled protective suits.

U.S. Pat. No. 3,710,395 (Jan. 16, 1973) and U.S. Pat. No. 5,960,475 (Oct. 5, 1999) disclose air permeable garments that provide for air circulation for cooling and evaporation. Their non-filtering construction renders them unsuitable for protective use.

U.S. Pat. No. 6,442,760 (Sep. 3, 2002) and U.S. Pat. No. 5,704,064 (Jan. 6, 1998) disclose ventilated suits that contain open vents in various locations in the suit to allow excess heat and moisture to escape. These openings prevent their use in most situations requiring protective suits. They do not have a mechanism to draw air through the suit. They provide minimal air circulation through the suit, limiting cooling and evaporation.

U.S. Pat. No. 5,564,124 (Oct. 15, 1996) and U.S. Pat. No. 4,903,694 (Feb. 27, 1990) disclose protective suits that use battery-powered blowers to ventilate the suit's interior. Such devices are expensive to produce, heavy and have a limited battery life.

U.S. Pat. No. 4,831,644 (May 23, 1989) discloses a ventilated protective hood attached to a protective suit that uses one-way valves to ventilate the hood and prevent condensation of the hood's window. It does not provide for ventilation of the protective suit.

U.S. Pat. No. 2,255,751 (Sep. 16, 1941), U.S. Pat. No. 2,573,414 (Oct. 30, 1951), U.S. Pat. No. 2,657,396 (Mar. 9, 1951), U.S. Pat. No. 3,292,179 (Dec. 29, 1966), U.S. Pat. No. 4,146,933 (Apr. 3, 1979), U.S. Pat. No. 4,172,454 (Oct. 30, 1979), U.S. Pat. No. 4,194,247 (Mar. 25, 1980), U.S. Pat. No. 4,286,439 (Sep. 1, 1981), U.S. Pat. No. 4,881,539 (Nov. 21, 1989), U.S. Pat. No. 4,458,680 (Jul. 10, 1984), U.S. Pat. No. 5,027,807 (Jul. 2, 1991), U.S. Pat. No. 5,355,857 (Oct. 18, 1994), U.S. Pat. No. 5,339,806 (Aug. 23, 1994) and U.S. Pat. No. 6,209,144 (Apr. 3, 2001) describe protective suits that use external sources for cooling and moisture evaporation, either stationary or carried by the wearer. Typical coolants are compressed bottled air or supplied air, which may also be used for breathing, or refrigerating fluids or gases circulated through the suit. These inventions require the use of a bulky heavy cooling device, carried by the individual, or the use of an external supply line that limits the mobility of the wearer. Their ventilation and cooling sources are expensive to produce. The present invention uses a lightweight breathing mask with one-way valves and the wearer's normal breathing to draw ambient air through the suit to cool the wearer. It does not require an external source of: power, refrigerants for cooling, or air for breathing, cooling and moisture removal.

### SUMMARY OF INVENTION

This invention discloses a ventilated protective suit composed of a permeable, impermeable or semi-permeable overgarment through which fresh air is drawn by the forces generated by the breathing of the wearer. A breathing mask with dual one-way valves is used to draw fresh through the suit: one of the one-way valves allows air to be drawn from the suits interior when the wearer inhales, the second valve allows the exhaled breath to be discharged to the atmosphere. Vents are situated in the suit to allow fresh air to enter the suit's interior, preferably near the body's extremities such as the hands, feet and head to provide the maximum area of the body to be exposed to the fresh air circulation. The suit is designed to prevent collapse, and the potential to lose air circulation, from the negative pressure created when air is drawn through it.

Particulate filters or chemical absorption elements can be placed in the air inlet vents to protect the wearer from potentially harmful agents such as dust, biological pathogens, radioactive materials or chemicals. They also prevent harmful elements from leaving the suit. Particulate filters or chemical absorption elements can be placed in the inlet or outlet ports of inlet or outlet one-way valves to prevent the passage of potentially harmful agents to the wearer or the surroundings and to prevent failure of the valves by an accumulation of contaminants in the valves.

The suit's body can be constructed of permeable or semi-permeable materials, allowing passage of at least some of the incoming fresh air to pass through the suit's body. In this design, the inlet air vents can be reduced in area or eliminated. The permeable or semi-permeable materials can be particulate filtering materials, or chemical adsorbing materials, to protect the wearer and the surroundings, or hydrophilic water displacing materials used for rain protection.

The suit can be constructed without filtering elements for use in such applications as: electromagnetic protection, physical trauma protection and rain protection.

Face shields and eye shields, with windows can be incorporated into the vented suit. The shield(s) have inlet vents to allow air to be drawn into the shield(s) to prevent condensation from fogging the window(s). The shield(s) are connected to the suit's interior by an extension of the suit's body or by any other well-known means, such as a tube or tubes. The connection from the shield(s) to the suit's body allows air to be drawn through the shield(s) then through the suit's interior to the breathing mask for inhalation. Particulate filter or chemical absorption elements can be placed in the shield(s) inlet vents.

The disclosed suit protects the wearer, or adjacent areas. The suit relieves the discomfort, exhaustion and heat stress associated with non-vented non-air-conditioned protective suits. The suit does not require power, coolant or external air. The suit's design provides for a less expensive, lighter weight, more mobile protective suit than the previously known ventilated or cooled suits. It eliminates the tendency to bypass a non-ventilated suit's protective properties by opening the suit's closures.

### DESCRIPTION OF SEVERAL VIEWS OF THE INVENTION

The drawing illustrates a preferred embodiment of the suit that is the object of the present invention.

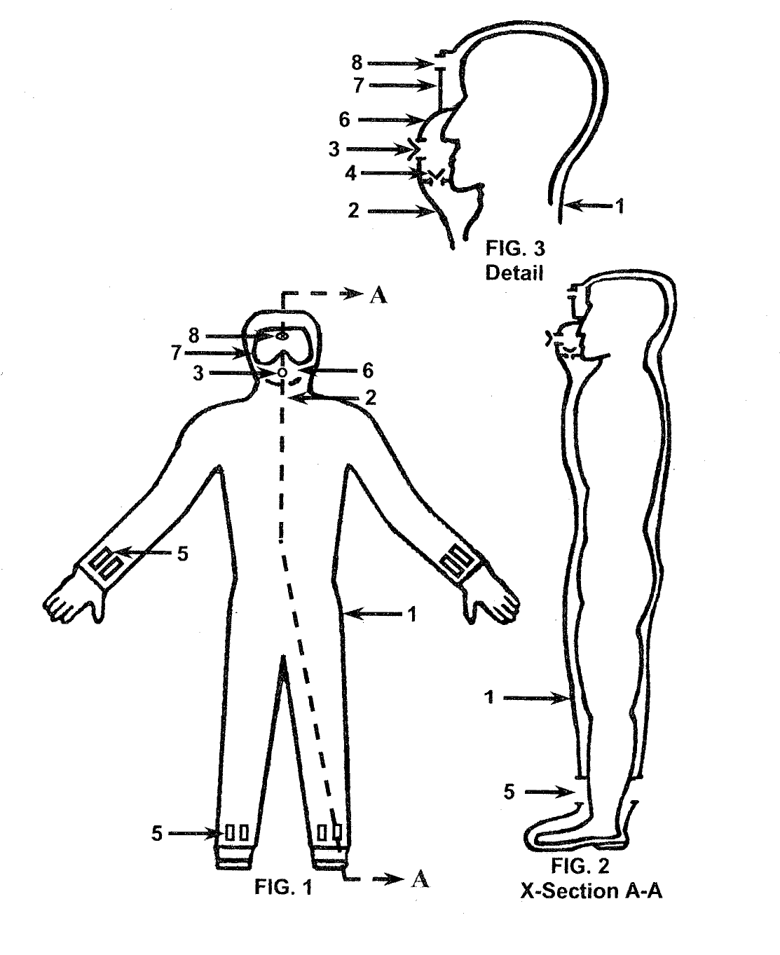

FIG. 1 is a front view of the suit.

FIG. 2 is a cross-sectional side view of the suit.

FIG. 3 is an expanded cross-sectional side view showing the detail of the breathing mask, face-shield and valving.

### DETAILED DESCRIPTION OF THE INVENTION

Item (1) is the suits body, constructed of a permeable, impermeable or semi-permeable material. The suit can cover the head, hands and feet of the wearer as shown. The suit can be designed to prevent collapse and the blockage airflow that could occur under the slight negative pressure generated while inhaling. Any of the well-known techniques to prevent loss of airflow can be used, such as incorporating: stays, reinforcing loops, three dimensional mesh, batting, convolutions tubes or netting.

Item (2) is an extension of the suit's body that connects to the breathing mask. The connection from the mask to the suit's interior could be constructed from a flexible tube or any other well-known connective device.

Item (3) is a one-way valve (also known as a check valve or automatic valve) that allows the exhaled air to exit the breathing mask to the ambient while preventing reverse flow into the breathing mask. It can be of any of the well-known designs such as flap valve or ball valve. It can be spring assisted, gravity assisted or mechanically assisted. The valve's ports can be filtered to prevent the escape of potentially harmful material from the suit or mask's interior and to prevent foreign matter from causing valve failure.

Item (4) is a one-way valve (also known as a check valve or automatic valve) which allows air to be drawn from the suits interior into the breathing mask while preventing reverse flow into the suit. It can be of any of the well-known designs such as flap valve or ball valve. It can be spring assisted, gravity assisted or mechanically assisted. The valve's ports can be filtered to prevent the passage of potentially harmful material from the suit's interior into the mask and to prevent foreign matter from causing valve failure.

Items (5) are air ambient air inlet vents that allow external air to enter the suit. They are preferably placed near the body's extremities such as the hands, feet and head. These vents can be equipped with particulate filters or chemical absorption elements to prevent ingress or egress of harmful materials.

Item (6) is a breathing mask that isolates the wearer's nose and mouth from both the ambient air and the suit's interior except for the airflow through the one-way valves. It is sealed to the wearer's face with any well-known technique such as a flexible lip around the mask's edges and a strap around the head.

Item (7) is a face shield with a sight window. It is connected to the suit's body to allow air to be drawn through the shield, then through the suit's body and into the breathing mask.

Item (8) is a vent in the face shield which allows ambient air to be drawn into the shield, preventing moisture buildup and fogging of the window. The vent can be equipped with a particulate filter or chemical absorption elements to prevent harmful agents from entering or exiting the shield and suit's interior.

When the wearer exhales, the exhaled breath exits the breathing mask though the outlet valve to the ambient. When the wearer inhales, fresh air is drawn through the vents and into the face shield, through the suit's interior and then into breathing mask for inhalation. Drawing the fresh air through the suit's interior removes body heat and perspiration. Drawing fresh air through the face shield prevents fogging of the sight window.

1) A ventilated breathing-powered protective suit consisting of:
a body constructed of an impermeable, semi-permeable or permeable material,
vents in the suit's body to allow ambient air to enter the suit's interior,
a breathing mask which covers at least the nose and mouth,
said breathing mask containing at least one one-way valve connected to the suit's body by an enclosed extension of the suit's body, sealed to the breathing mask or the valve's inlet port, or connected by any other well known technique such as a flexible tube, to allow ambient air to be drawn through the suit's interior and,
said breathing mask containing at least one one-way valve to exhaust the exhaled air to the ambient.

2) A protective suit described in claim (1) that fully covers the body.

3) A protective suit described in claim (1) that partially covers the body, such as: uncovered hands, uncovered feet, an upper body covering only or a lower body covering only.

4) A protective suit described in claim (1) constructed, at least partially, of a permeable or semi-permeable material that is capable of passing a sufficient quantity of air into the suit's interior without air inlet vents in the suit's body.

5) A protective suit described in claim (4) in which the permeable or semi-permeable material is capable of filtering particulates or chemical elements or is hydrophilic.

6) A protective suit described in claim (1) in which the vents that allow air to enter the interior of the suit are areas that are commonly designed to be open such as the end of the legs and arms, the waist of a jacket, under arm vents, back vents and closures such as zippers and buttons.

7) A protective suit with a breathing mask described in claim (1) which has one or more one-way valve elements in the one-way valves, connected in series, to allow for continued operation of the valves if one of the valve elements fails open (fails to close off the reverse flow of air).

8) A protective suit described in claim (1) that is constructed to resist collapse under the negative pressure created when inhaling, using supports such as: stays, reinforcing loops or convolutions.

9) A protective suit described in claim (1) that has an inner three dimensional lining, such as mesh, batting, netting or tubes that allows air to pass through the lining, and the suit's interior, when the suit collapses under the negative pressure created when inhaling.

10) A protective suit described in claim (1) that contains permanently attached particulate filtration and/or chemical absorption elements in the valve ports.

11) A protective suit described in claim (1) that contains replaceable particulate filtration and/or chemical absorption elements in the valve ports.

12) A protective suit described in claim (1) that contains permanently attached particulate filtration and/or chemical absorption elements in the air inlet vents.

13) A protective suit described in claim (1) that contains replaceable particulate filtration and/or chemical absorption elements in the air inlet vents.

14) A protective suit described in claim (1) in which the air vents are shielded to prevent entry of falling liquids such as rain.

15) A protective suit described in claim (1) that has an face shield, or hood, covering the eyes and unprotect areas of the head, sealed to the wearer's face containing:
a sight window, or windows, for vision,
an air inlet vent or vents to allow air to be drawn into the shield, and
an air outlet vent or vents, connected to the suit's interior by an enclosed extension of the suit's body, or any other well-known connection technique such as a flexible tube, to allow air to be drawn from the shield into the suit's interior.

16) A face shield described in claim (15) that has permanently attached particulate filtration and/or chemical absorption elements in the air inlet vents.

17) A face shield described in claim (15) that has replaceable particulate filtration and/or chemical absorption elements in the air inlet vents.

18) A protective suit described in claim (1) with a full face shield, or hood, covering the face and the head of the wearer and the breathing mask, that has:
a connection from the breathing mask's exhaled air's one-way valve(s) exit port(s) to the ambient using any of the well-known techniques, such as a flexible tube passing through the shield's exterior or the suit's exterior or by a direct connection between the exit valve and a vent port in the shield or suit, to allow the exhaled air to exit the breathing mask to the ambient,
an air outlet vent, or vents, connected to the suit's interior by an extension of the suit's body, or any other well-known connection technique between the shield's vents and the suit's interior such as a flexible tube, to allow air to be drawn through the shield into the suit's interior,
a sight window.

19) A full-face shield described in claim (18) that has air inlet vents in the shield to allow air to be drawn through the shield to prevent fogging of the sight window.

20) A full-face shield described in claim (19) that contains permanently attached particulate filtration and/or chemical absorption elements in the air inlet vent(s).

21) A full-face shield described in claim (19) that contains replaceable particulate filtration and/or chemical absorption elements in the air inlet vent(s).
